(19) United States
(12) Patent Application Publication
(10) Pub. No.: US 2008/0099647 A1
(43) Pub. Date: May 1, 2008

(54) Glass holder

(75) Inventor: Kei SHIMOZAKI, Utsunomiya-shi (JP)

Correspondence Address: KANESAKA BERNER AND PARTNERS LLP, 1700 DIAGONAL RD, SUITE 310, ALEXANDRIA, VA, 22314-2848, US

(73) Assignee: NIFCO INC., Yokohama-shi (JP)

(21) Appl. No.: 11/907,858

(22) Filed: Oct. 18, 2007

(30) Foreign Application Priority Data
Oct. 30, 2006 (JP) 2006-293586

(51) Int. Cl. E05D 3/02; E05D 1/00

(52) U.S. Cl. 248/309.2; 248/309.1; 248/316.1

(57) ABSTRACT

A glass holder, used when a window glass is attached to a connection portion, includes a first supporting plate portion; a second supporting plate portion; and a hinge portion disposed between the first and second supporting plate portions so that the first and second supporting plate portions face each other. Through-bores are disposed at the first and second supporting plate portions. A temporary locking device projects from one of the two supporting plate portions to be able to lock with the window glass by being inserted into the mounting bore in a non-clamped condition where the supporting plate portions open through the hinge portion.

### BACKGROUND OF THE INVENTION AND RELATED ART STATEMENT

The invention relates to a glass holder which is used when, especially, a window glass is tightened to a connection portion such as a carrier plate and the like by a bolt and a female screw portion.

FIGS. 9, 10 show a glass holder (glass-fixing grommet) described in Patent Document 1 (Japanese Patent Application No. 2005-97878). This glass holder 3 is located in a door 1 of an automobile and used when a window glass 2 is attached to carrier plates 4 which move up and down by a lifting-and-lowering mechanism 5 in a state of clamping a lower peripheral border portion of the window glass 2. The structure of the glass holder 3 includes a first supporting plate portion 6 and a second supporting plate portion 8 which face each other through a hinge portion; a through-bore (bolt entrance bore) 13 and a through-bore (a bolt exit bore) 23 provided at both supporting plate portions 6, 8 corresponding to bolt insertion bores provided in a mounting bore 12 and the carrier plates 4 provided in the peripheral border portion of the window glass 2; and an external cylinder 10 and an internal cylinder 20 provided at the first supporting plate portion 6 and the second supporting plate portion 8. Inside the mounting bore 12 of the window glass 2, the external cylinder 10 and the internal cylinder 20 are fitted to each other, so that both supporting plate portions 6, 8 clamp the window glass 2. With the clamped condition, the window glass 2 is tightened to the carrier plates 4 by a bolt 16 which is inserted through the bolt insertion bores of the carrier plates 4 and the female screw portion of a nut 31. The reference numeral 7 represents a connection plate portion of the second supporting plate portion 8. A hinge portion is formed between the connection plate portion 7 and the first supporting plate portion 6.

This structure is improved in the following respects. The second supporting plate portion 8 is provided between an inner plate portion 17 and an outer plate portion 18, and a holding space which holds a guard portion 32 of the nut 31 is provided. The external cylinder 10 and the internal cylinder 20 include engaging pieces 14, 21 which are fitted to each other and not able to move away from each other. A movable piece (not shown) wherein the external cylinder 10 is provided in a part, fitted into the internal cylinder 20, expands the diameter, and is pressed against the inner periphery of the mounting bore 12, is included.

The mounting procedure of the above-mentioned structure is as follows. First, after the glass holder 3 is temporarily attached to the window glass 2, the glass holder 3 is tightened to the carrier plate 4 by the bolt 16. Here, in the temporary mounting operation of the glass holder 3 relative to the window glass 2, after the first supporting plate portion 6 is abutted against one face of the window glass 2 by inserting the external cylinder 10 into the mounting bore 12, the second supporting plate portion 8 is folded toward the other face of the window glass 2 through the hinge portion of the connection plate portion 7. Then, the internal cylinder 20 is fitted into the external cylinder 10, and the engaging pieces 14, 21 are engaged, so that the second supporting plate portion 8 cannot move away from the first supporting plate portion 6, and the peripheral border portion of the window glass 2 is clamped between the second supporting plate portion 8 and the first supporting plate portion 6. In this clamped condition, the glass holder 3 is attached to the window glass 2 in a state wherein the above-mentioned movable piece on the external cylinder side is pressed against the inner periphery of the mounting bore 12.

Also, an inner bore of the internal cylinder 20 and the female screw portion of the nut 31 which is retained by the second supporting plate portion 8 are located on the coaxial line. From this state, after the first supporting plate portion 6 is positioned relative to the carrier plates 4, the bolt 16 is screwed to the female screw portion of the nut 31 through the bolt insertion bores of the carrier plates 4, the through-bore 13 of the first supporting plate portion 6, the internal cylinder 20, and the through-bore 23 of the second supporting plate portion 8.

The above-mentioned conventional structure had the following disadvantages in the temporary attaching operation of the glass holder 3 relative to the window glass 2 and the tightening operation relative to the carrier plate 4.

1) In a non-clamped condition wherein both supporting plate portions 6, 8 are opened through the hinge portion, the external cylinder 10 of the first supporting plate portion 6 is inserted into the mounting bore 12 of the window glass 2. While maintaining the inserted state, the second supporting plate portion 8 has to face the first supporting plate portion 6 through the hinge portion, and the internal cylinder 20 has to be inserted into the inside of the external cylinder 10 within the mounting bore 12, so that the workability is inefficient. More specifically, in this temporary attaching operation, the first supporting plate portion 6 has to be pressed into a window glass 2 side until both engaging pieces 14, 21 are engaged with each other so that the external cylinder 10 does not come away from the mounting bore 12. This is because when the second supporting plate portion 8 is folded in the clamped condition, stress is applied to the external cylinder 10 in a direction of slipping, or when the internal cylinder 20 is inserted into the external cylinder 10 through the mounting bore 12, the end claw portion of the engaging piece 21 presses the external cylinder 10 in a direction of slipping out of the mounting bore 12.

2) In the conventional structure, for example, in the temporary attached state of the glass holder 3 relative to the window glass 2, the second supporting plate portion 8 can slightly move up and down through the thin-walled belt-like hinge portion. As a result, the through-bore 23 of the second supporting plate portion 8 or the shaft center of the nut 31 might not correspond to the through-bore 13 (and the bolt insertion bores of the carrier plates 4) of the first supporting plate portion 6. In such a case, the bolt 16 cannot be screwed and tightened well relative to the nut 31.

3) It is preferable to make the bore diameter of the mounting bore 12 as small as possible. However, if the external cylinder 10 and the internal cylinder 20 are fitted to each other within the mounting bore, the bore diameter of the mounting bore 12 tends to be larger.

This invention is made in order to solve the above-mentioned problem, and an object of the invention is to perform the temporary attaching operation easier and perform the tightening operation by the bolt excellently, or to make the bore diameter of the mounting bore on the window glass side relatively smaller, so that it is possible to improve its workability and reliability.

Further objects and advantages of the invention will be apparent from the following description of the invention.

### SUMMARY OF THE INVENTION

The present invention according to the first aspect is specified from a structure of a temporary locking means of an embodiment and a modified example, and used when a window glass is attached to a connection portion such as a carrier plate and the like. The invention includes a first supporting plate portion and a second supporting plate portion which face each other through a hinge portion; a mounting bore provided in the peripheral border portion of the window glass; and a through-bore corresponding to a bolt insertion bore provided in the connection portion and provided in both supporting plate portions. A glass holder (hereinafter, this structure is called a premise requirement) tightens the connection portion by a bolt which is inserted from the bolt insertion bore and a female screw portion which is screwed to the bolt in the condition wherein the window glass is clamped by both supporting plate portions. The glass holder includes a temporary locking means projecting to one of the two supporting plate portions and locking in the window glass by being inserted into the mounting bore in a non-clamped condition wherein each supporting plate portion is opened through the hinge portion.

In the above-mentioned structure, among both supporting plate portions, it is preferable to include holding means respectively provided near the hinge portion, engaging each other in a condition wherein the window glass is clamped between both supporting plate portions, and holding the clamped condition by both supporting plate portions (the second aspect of the invention).

The invention according to the third aspect is specified from the structure of the holding means of the embodiment and the modified example. In the premise requirement, among both supporting plate portions, the holding means are respectively provided near the hinge portion, engaging each other in a condition wherein the window glass is clamped between both supporting plate portions, and holding the clamped condition by both supporting plate portions.

The invention according to the fourth aspect specifies the embodiment more clearly, and includes a roughly tube-shaped insertion portion which is provided in one of the two supporting plate portions and inserted into the mounting bore of the window glass; temporary locking claws forming a part of the insertion portion respectively and locking in the window glass by inserting the insertion portion into the mounting bore in the non-clamped condition of each supporting plate portion; and a wobble-absorbing bulging portion which expands the diameter when the bolt is inserted into the inner bore of the insertion portion through the bolt insertion bore, and presses against the inner periphery of the mounting bore. In the above-mentioned structure, it is preferable that the locking claws and/or bulging portion are included at least in three places (the fifth aspect of the invention).

The invention according to the sixth aspect specifies a modified example 2 more clearly, and includes among both supporting plate portions, the holding means respectively provided near the hinge portion, engaging each other in the condition wherein the window glass is clamped between both supporting plate portions, and holding the clamped condition by both supporting plate portions; the roughly tube-shaped insertion portion which is provided in one of the two supporting plate portions and inserted into the mounting bore of the window glass; and the temporary locking claws provided in one part of the insertion portion and locking in the window glass by inserting the insertion portion into the mounting bore in the non-clamped condition of each supporting plate portion. Also, in the above-mentioned respective structures, it is preferable to include a bolt retaining portion which retains the bolt (the seventh aspect of the invention).

In the first aspect of the invention, in the temporary attaching operation of the glass holder to the window glass, in the non-clamped condition wherein both supporting plate portions are opened, one of the two supporting plate portions is inserted into the mounting bore of the window glass, so that the glass holder is retained and locked to the window glass by the temporary locking means. Consequently, this structure can easily change both supporting plate portions from a temporary locked state of one of the two supporting plate portion relative to the window glass to the clamped state by folding the other of the two supporting plate portions as a supporting point of the hinge portion. In this case, in the invention of the second aspect, since the clamped condition of both supporting plate portions is further maintained by the holding means, through-bores of both supporting plate portions can be kept on the coaxial line as designed, so that the tightening operation by the bolt can be performed excellently.

In the third aspect of the invention, as in the case of the second aspect, since the clamped condition of both supporting plate portions is maintained by the holding means, even if the hinge portion is thin-walled belt-like, i.e. a type which can subtly move up and down, the movement caused by the hinge portion is controlled by the holding means. As a result, both through-bores of both supporting plate portions are kept on the coaxial line as designed, so that the tightening operation by the bolt can be performed excellently.

In the fourth aspect of the invention, as shown in FIGS. 4, 5, among both supporting plate portions, when the insertion portion is inserted into the mounting bore of the window glass, one of the two supporting plate portions is retained and locked through the locking claws provided in the insertion portion. As mentioned above, by temporarily locking one of the two supporting plate portions relative to the window glass, the following temporary attaching operation can be easily performed. At the same time, when the bolt is inserted into the inner bore of the insertion portion through the bolt insertion bore of the connection portion, the bulging portion provided in the insertion portion expands its diameter and presses against the inner periphery of the mounting bore of the window glass. As a result, a space relative to the mounting bore disappears, and a stable tightening state can be obtained. In this case, in the invention of the fifth aspect, at least three bulging portions press against the mounting bore, so that a centering function can be expected. Also, by locking by three locking claws, the stress concentration can be reduced.

In the sixth aspect of the invention, as shown in FIG. 8, among both supporting plate portions, when the insertion portion is inserted into the mounting bore of the window glass, one of the two supporting plate portions is retained and locked through the locking claws provided in the insertion portion. At the same time, since the clamped condition of both supporting plate portions is maintained by the holding means, both through-bores of both supporting plate portions are kept on the coaxial line as designed, so that the tightening operation by the bolt can be performed excellently.

In the seventh aspect of the invention, in a state wherein the glass holder is temporarily attached to the window glass, and positioned relative to the connection portion, the bolt is retained by the bolt retaining portion at the early stage wherein the bolt is inserted into the mounting bore of the window glass or the insertion portion from the bolt insertion bore of the connection portion, i.e. the stage before the bolt is screwed to the female screw portion. Accordingly, in this structure, for example, the temporary locking operation and the setting operation of the bolt; and the tightening operation wherein the bolt is rotated and screwed to the female screw portion can be performed separately. As a result, workability can be improved.

### BRIEF DESCRIPTION OF THE DRAWINGS

FIG. 1 is a schematic outline view showing a glass holder according to an embodiment in a non-clamped condition wherein the glass holder is opened;

FIGS. 2(a)-2(c) show the glass holder in the non-clamped condition, wherein FIG. 2(a) is a top view, FIG. 2(b) is a bottom view, and FIG. 2(c) is a side view;

FIG. 3(a) is an enlarged sectional view taken along line 2(a)-2(a) in FIG. 2(a), FIG. 3(b) is an enlarged sectional view taken along line 3(b)-3(b) in FIG. 2(a), and FIG. 3(c) is an enlarged sectional view taken along line 3(c)-3(c) in FIG. 2(a).

FIG. 4 is an enlarged sectional view showing a state wherein the glass holder is temporarily attached to a window glass;

FIG. 5 is an enlarged sectional view taken along line 5-5 in FIG. 2(b) which shows the state wherein the window glass is tightened to a connection portion using the glass holder;

FIG. 6 is a drawing showing a glass holder of a modified example 1 in the same condition as FIG. 5;

FIG. 7 is a schematic outline view showing a glass holder of a modified example 2 in a non-clamped condition;

FIG. 8 is an enlarged sectional view showing a state wherein the window glass is tightened to the connection portion using the glass holder in FIG. 7;

FIG. 9 is an explanatory drawing showing the glass holder disclosed in Japanese Patent Publication No. 2005-97878 as a used example of the glass holder; and

FIG. 10 is an enlarged sectional view showing a state wherein the window glass is tightened to the connection portion using the glass holder disclosed in Japanese Patent Publication No. 2005-97878.

### DETAILED DESCRIPTION OF PREFERRED EMBODIMENTS

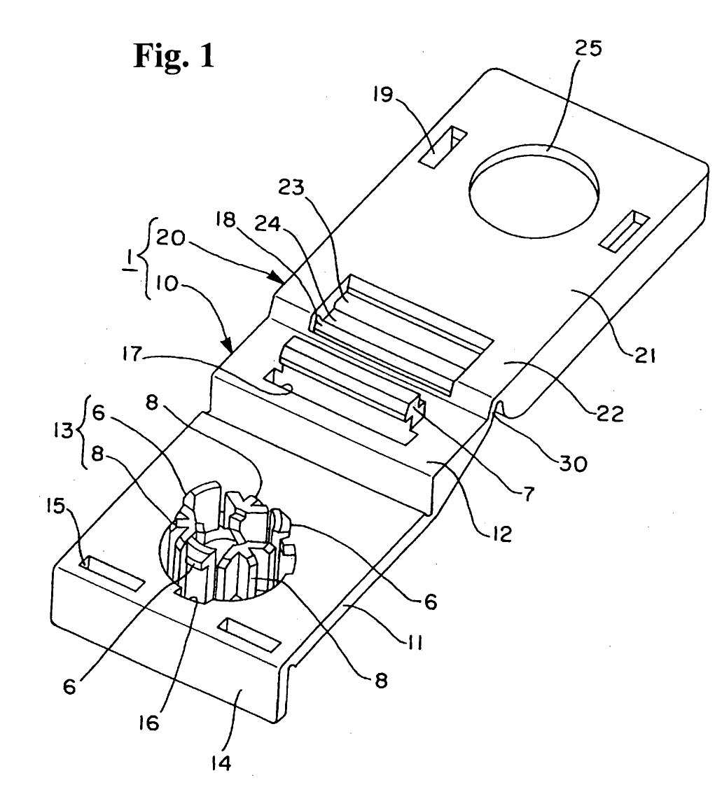

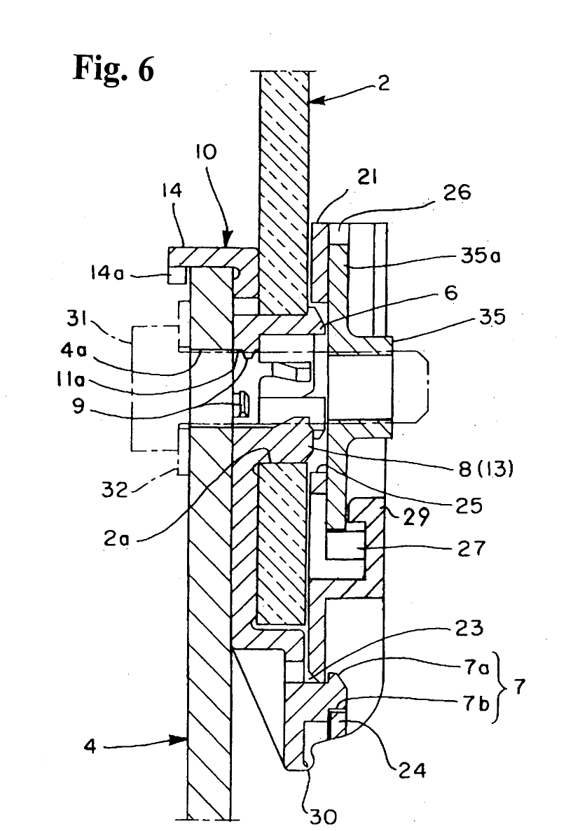

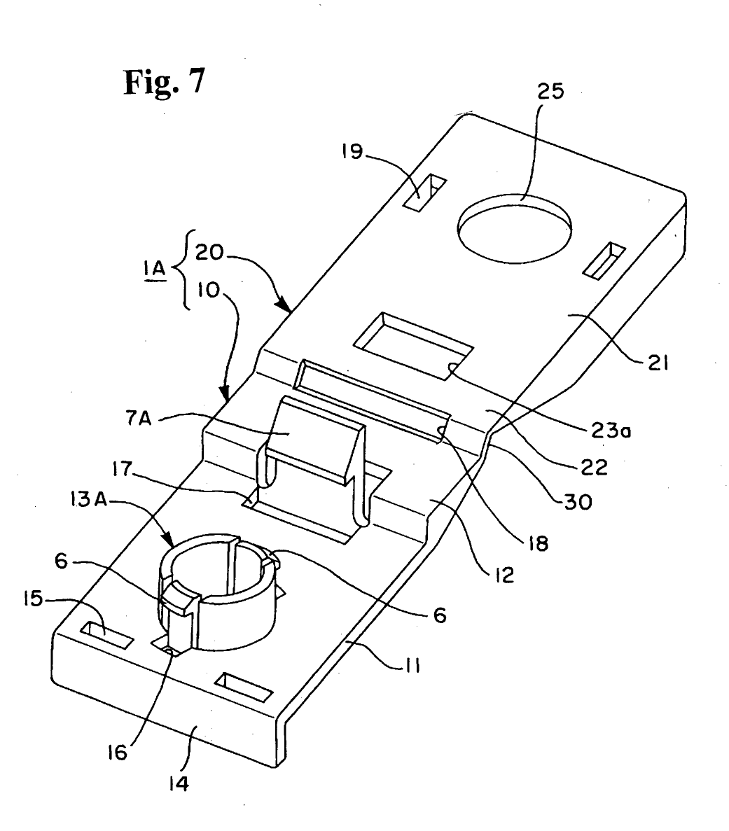

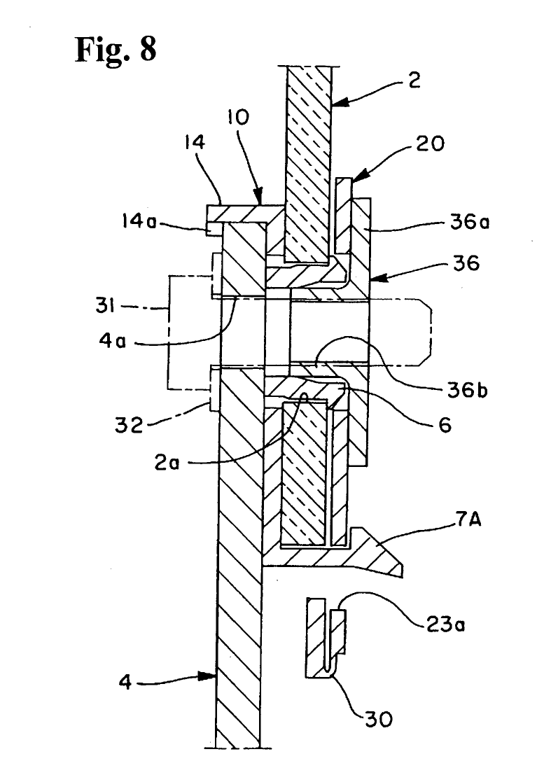

Hereunder, embodiments of the present invention will be explained with reference to the accompanying drawings. In this explanation, the structure of the basic embodiment and the attaching operation will be described with reference to FIGS. 1˜5, and then a modified example 1 in FIG. 6 and a modified example 2 in FIGS. 7, 8 will be described.

(Structure)

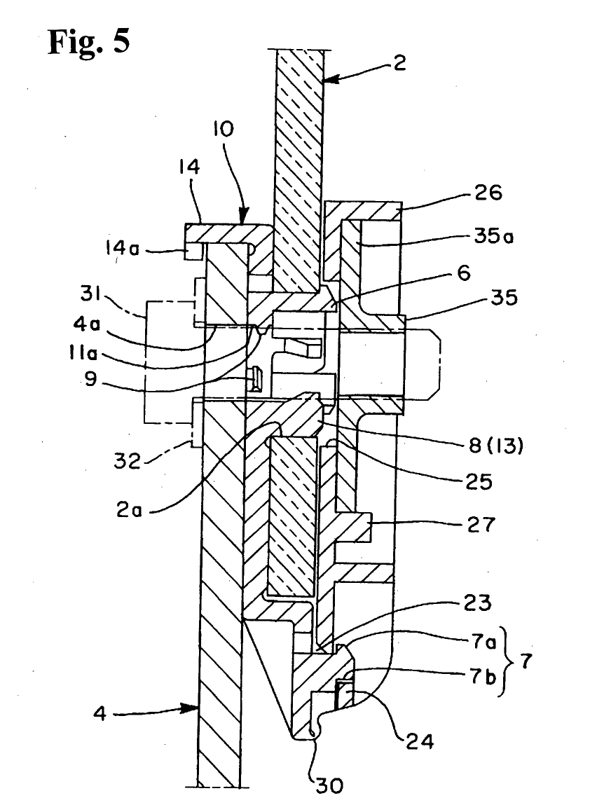

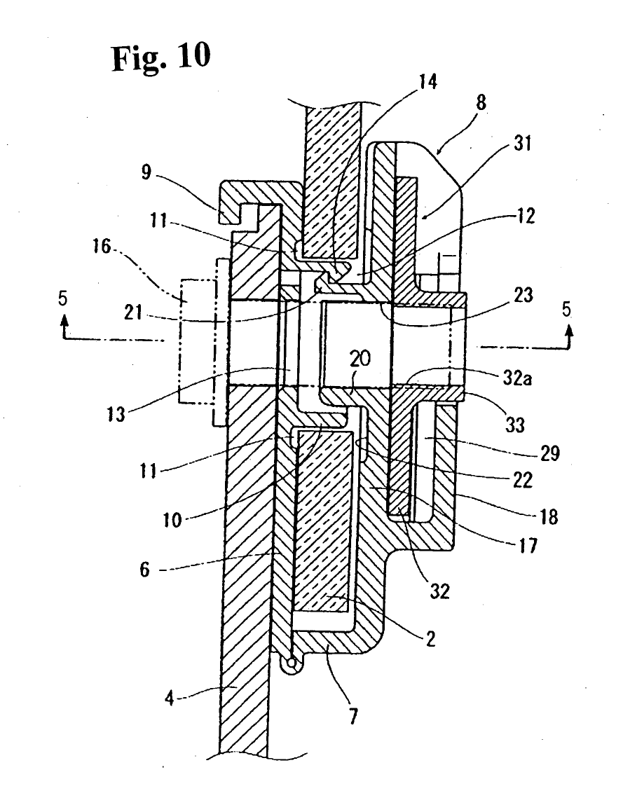

The glass holder 1 comprises a resin molding member. For example, as in the case of the glass holder in FIG. 10 (the glass holder represented by the reference numeral 3 in FIG. 10), the glass holder 1 is located in an automobile door, and used when the glass holder 1 is tightened to a carrier plate 4 which configures a lifting-and-lowering mechanism 5 and is moved up and down in a state wherein the glass holder 1 is temporarily attached to the lower peripheral border portion of the window glass 2. Also, in the glass holder 1, a first supporting plate portion 10 which is arranged on one face of the window glass 2 and a second supporting plate portion 20 which is arranged on the other face of the window glass 2 are connected through a hinge portion 30. The glass holder 1 can switch the condition of both supporting plate portions 10, 20 between a non-clamped condition wherein, as shown in FIG. 1, both supporting plate portions 10, 20 are opened through the hinge portion 30 and a clamped condition wherein, as shown in FIG. 5, both supporting plate portions 10, 20 face each other through the hinge portion 30 and clamp the peripheral border portion of the window glass 2.

The first and second supporting plate portions 10, 20 have a roughly short plate shape, and include locking claws 6 as temporary locking means which project from the first supporting plate portion 10 and lock in the window glass 2 in a retaining state by inserting the window glass 2 into a mounting bore 2a in the non-clamped condition; an engaging piece 7 and a locking bore 23 as holding means which are provided in both supporting plate portions 10, 20, engage each other in the clamped condition, and maintain the clamped condition; wobble-absorbing bulging portions 8 which are respectively provided in the first supporting plate portion 10, expand the diameter by inserting a bolt 31, and press against the inner periphery of the mounting bore 2a; and retaining portions 9 which elastically engage with a valley of a male screw portion of the bolt 31 and prevent the bolt from slipping.

Here, the first supporting plate portion 10 comprises a glass abutting portion 11 which is provided from the end side of the first supporting plate portion 10 to just before the hinge portion 30 and can contact with one face of the window glass 2; and a step portion 12 which is provided from the glass abutting portion 11 to the hinge portion 30, absorbs the thickness of the window glass 2, and is one step higher. The engaging piece 7 is projected from the step portion 12 in a width direction, and includes a claw 7a provided at the end and projecting to an insertion portion 13 side; and a step portion 7b provided on the other side and projects to three places of both sides and the intermediate part of the width.

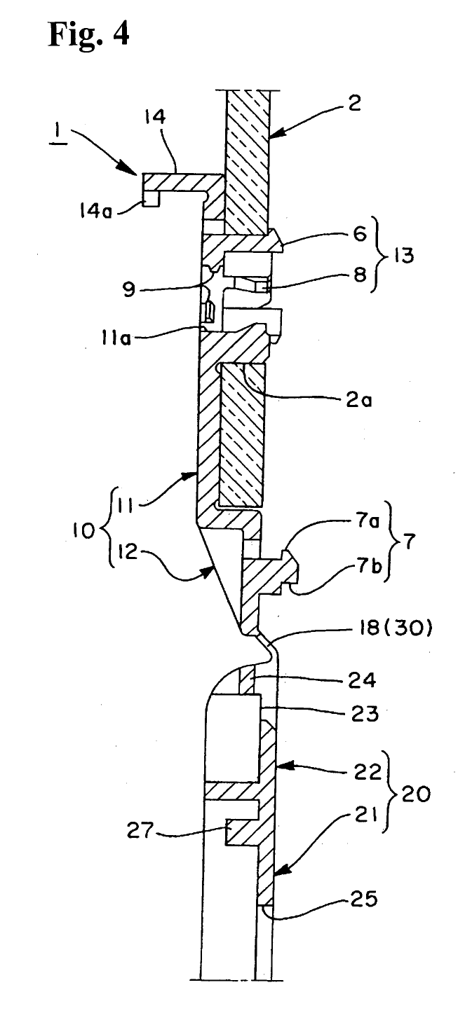

As shown in FIG. 4, the glass abutting portion 11 includes a through-bore 11a for a bolt entrance which penetrates in a roughly central part; an insertion portion 13 provided in the top surface (face arranged on the inside in the clamped condition), projecting in such a way as to surround the through-bore 11a, and inserted into the mounting bore 2a of the window glass 2; and a folded portion 14 folded in an L shape from the end side to a lower surface (face arranged on the outside in the clamped condition) side. The through-bore 11a is a bore penetrating the bolt 31.

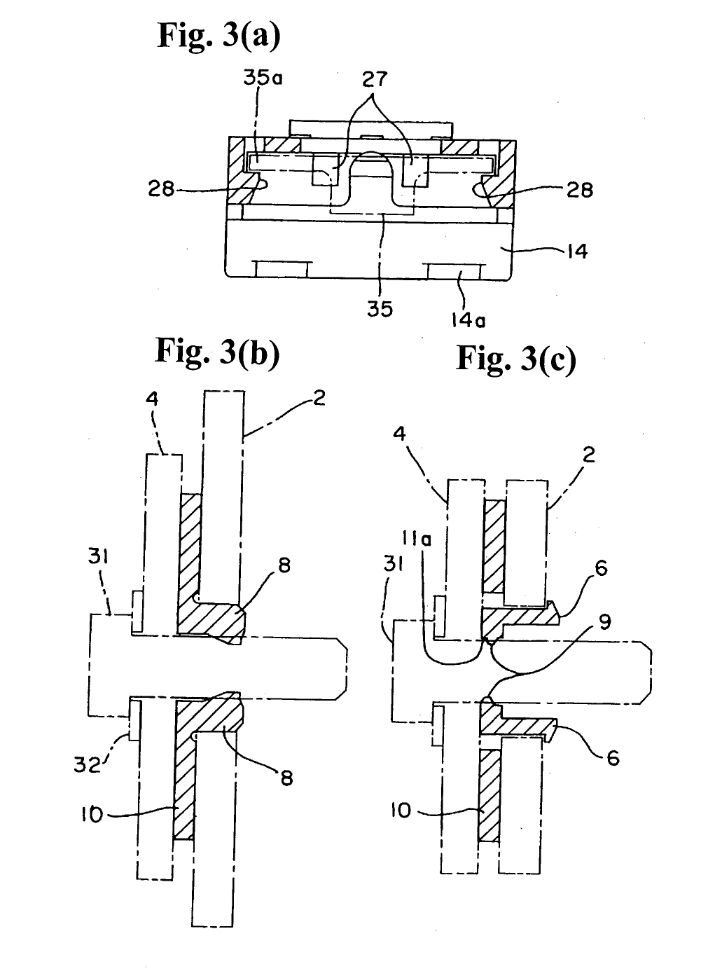

As shown in FIG. 3(c), the multiple (three in this example) retaining portions 9 elastically engaging with the valley of the male screw portion of the bolt 31 are provided in the inner periphery of the through-bore 11a. The insertion portion 13 consists of three locking claws 6 and three bulging portions 8 arranged on a concentric circle with the center of the through-bore 11a and projecting at certain intervals. Each locking claw 6 is provided in three places wherein the surrounding area of a tube shape is divided equally, and includes an outward-looking claw at the end of the piece. When the locking claw 6 is penetrated through the mounting bore 2a while shrinking the diameter, the locking claw 6 is elastically restored to its original state and locked in the rim of the mounting bore 2a. Each bulging portion 8 is projected lower than the locking claw 6 between the locking claws 6 in three places wherein the surrounding area of the tube shape is divided equally. When the bolt 31 is inserted, the diameter of the bulging portion 8 expands and is pressed against the inner periphery of the mounting bore 2a.

The folded portion 14 includes a portion 14a projecting further from multiple end places in a roughly L shape. The portion 14a prevents the upper end of the carrier plate 4 from slipping in a state wherein the upper end of the carrier plate 4 is abutted against the inside of the folded portion 14 (refer to FIG. 5). Incidentally, reference numerals 15˜17 represent bores formed for a cutter and the reference numeral 18 represents a bore sectioning the hinge portion 30. The hinge portion 30 is formed in both side portions of the plate width by the bore 18.

On the other hand, the second supporting plate portion 20 comprises a glass abutting portion 21 which forms from the end side to just before the hinge portion 30 and can contact with the other face of the window glass 2; and a portion 22 whose one part overlaps the step portion 12 in the clamped condition. The portion 22 includes the locking bore 23 engaging with the engaging piece 7 by pressing the engaging piece 7. As shown in FIG. 4, in the locking bore 23, the end face on the side wherein the locking bore 23 is away from the hinge portion 30 is formed in an inclined surface. Also, a portion 24 between the locking bore 23 and the bore 18 is formed at one step lower portion. As a result, as shown in FIG. 5, when the engaging piece 7 is engaged with the locking bore 23, the claw 7a can easily pass through the locking bore 23 along the inclined surface, and once the engaging piece 7 is engaged with the locking bore 23, the engaging piece 7 is hard to be slipped. Also, by abutting the step portion 7b against the portion 24, the engaging piece 7 is controlled so as not to be excessively inserted into the locking bore 23.

The glass abutting portion 21 includes a through-bore 25 which also functions as an exit for the bolt penetrating the insertion portion 13; a folded portion 26 folded in an L shape from the end side to the lower surface (face arranged on the outside in the clamped condition) side; multiple projections 27 located on the lower surface and positioning a guard portion 35a of a nut 35 with the folded portion 26; and claw portions 28 for locking the nuts projecting on both sides of the through-bore 25. As shown in FIG. 5, the nut 35 arranges the guard portion 35a between the folded portion 26 and the projections 27 relative to the external surface of the glass abutting portion 21. Also, as shown in FIG. 3(a), by retaining the nut 35 by each claw portion 28 facing each other, the nut 35 is placed on the coaxial line of the through-bore 11a. Incidentally, the reference numeral 19 represents a bore formed as a cutter.

(Mounting Operation)

Next, the tightening operation wherein the window glass is tightened by the bolt 31 and the nut 35 relative to the carrier plate 4 as a connection portion using the glass holder 1 will be explained. In this structure, first, the glass holder 1 is temporarily attached to the window glass 2. In this operation, as shown in FIG. 4, the insertion portion 13 is pushed into the mounting bore 2a provided in the window glass 2 in the non-clamped condition wherein the glass holder 1 is opened. Then, the glass holder 1 is pressed into the bore while each locking claw 6 reduces the diameter relative to the mounting bore 12a, and when the locking claw 6 passed through, the locking claw 6 restores to its original state and is locked and retained. Herewith, in this structure, after the glass holder 1 is temporarily attached to the window glass 2, the glass holder 1 does not slip due to vibration.

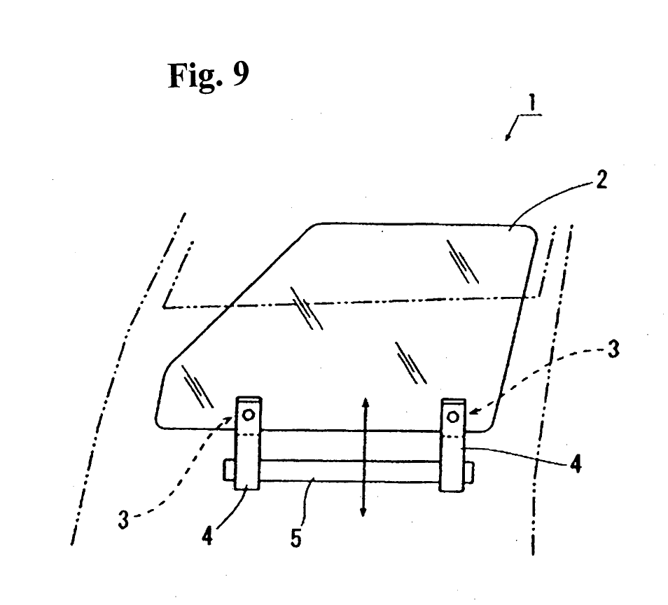

The window glass 2 is put into the door assembling process in a state wherein the glass holder 1 is temporarily attached. In this case, usually, the window glass 2 is put into the door assembling process after the state in FIG. 4 is switched to the clamped condition by folding the second supporting plate portion 20 to the window glass 2 side through the hinge portion 30. More specifically, in this structure, when the second supporting plate portion 20 is folded to the window glass 2 side, the engaging piece 7 is elastically engaged with the locking bore 23 as mentioned above and switched to the clamped condition, and maintained in the clamped condition. The advantages of this structure are as follows. In addition to being able to switch from the non-clamped condition to the clamped condition with just a single touch of a button, since the engagement between the engaging piece 7 and the locking bore 23 is configured above the hinge portion 30 as shown in FIG. 5, once the engagement is completed, the glass abutting portion 21 is positionally fixed. This contrasts with the second supporting plate portion 20 which has a tendency to subtly move up and down due to the thin-walled belt-like hinge portion in FIG. 9.

In this structure, the above-mentioned up-and-down movement of the second supporting plate portion 20 can be reliably eliminated due to the engagement between the engaging piece 7 and the locking bore 23, so that the through-bore 23 relative to the through-bore 11a and the nut 35 retained on the lower surface as mentioned above is arranged on the coaxial line with high dimensional accuracy as designed. Also, the tightening operation of the after-mentioned bolt 31 can be excellently maintained.

More specifically, in the door assembling process, the window glass 2 is tightened to the carrier plate 4 by the tightening operation of the bolt 31 relative to the nut 35 through the glass holder 1. In the carrier plate 4, a bolt insertion bore 4a is provided beforehand. In this tightening operation, first, in the state wherein the window glass 2 is temporarily attached to the glass holder 1, while the inner surface of the folded portion 14 is being retained on the upper end of the carrier plate 4, the external surface of the first supporting plate portion 10 abuts against the corresponding surface of the carrier plate 4. Herewith, the through-bore 11a of the first supporting plate portion 10 is arranged on the coaxial line with the bolt insertion bore 4a of the carrier plate 4, and the window glass 2 is positioned relative to the carrier plate 4. Consequently, the bolt 31 is screwed and tightened to the female screw portion of the nut 35 through a lock washer 32, the bolt insertion bore 4a, the through-bore 11a, the inner diameter of the insertion portion 13, and the through-bore 25.

In the above-mentioned tightening operation of the bolt 31, the clamped condition of both supporting plate portions 10, 20 is maintained by the engagement between the engaging piece 7 and the locking bore 23, so that even if the hinge portion 30 is a thin-walled belt-like type, i.e. can subtly move up and down, the movement resulted primarily from the hinge portion can be controlled, and the through-bore 11a, the through-bore 25, and the female screw portion of the nut 35 can be kept on the coaxial line with high dimensional accuracy. As a result, the tightening operation by the bolt 31 can be conducted excellently. Also, in this structure, when the bolt 31 is inserted into the through-bore 11a and the internal bore of the insertion portion 13 from the bolt insertion bore 4a of the carrier plate 4, the bulging portion 8 comprising the insertion portion 13 expands the diameter and is pressed against the internal periphery of the mounting bore 2a of the window glass 2. This eliminates a gap, so that a stable tightening state can be obtained.

In this case, the multiple bulging portions 8 are provided in places wherein the tube shape is divided equally, so that a centering function can be also expected. Additionally, in this structure, in the first stage wherein the bolt 31 is inserted into the insertion portion 13 from the bolt insertion bore 4a of the carrier plate 4, i.e. the stage before the bolt 31 is screwed to the nut 35, the retaining portions 9 are engaged with the valley of the male screw portion of the bolt 31, and retained so as not for the bolt 31 to slip improperly. Consequently, in this structure, for example, the temporary locking operation and setting operation of the bolt 35; and the tightening operation of rotating the bolt 35 and screwing the bolt 35 to the female screw portion of the nut 35 can be conducted separately. Consequently, the workability can be improved.

### Modified Example 1

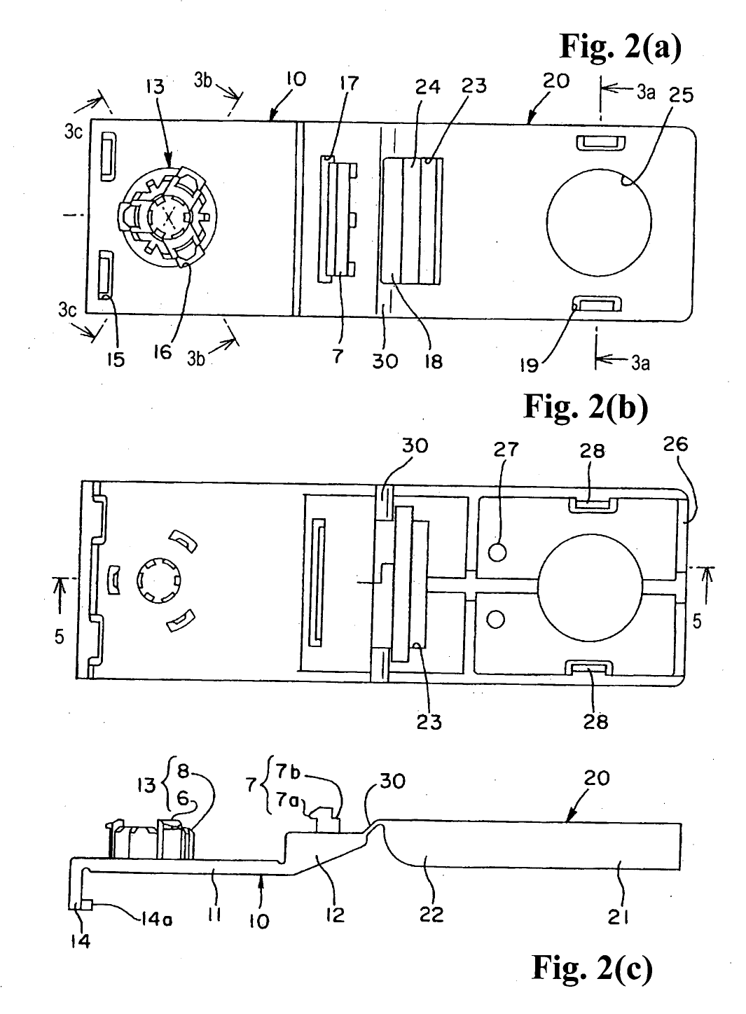

FIG. 6 shows an example wherein the structure holding the nut among the glass holder 1 is modified. Incidentally, compared with FIG. 5, FIG. 6 is an enlarged sectional view wherein the glass holder is sectioned in the middle. In the glass holder in FIG. 6, the same symbols are assigned to the substantively same parts with embodiments in FIGS. 1-5, and only change will be explained. In other words, in this modified example, the folded portion 26 is formed slightly lower, and a holding piece portion 29 which holds the guard portion 35a of the nut 35 to a projection 27 side from the outside is additionally provided. The nut 35 is moved to the lower surface of the glass abutting portion 21 from the end portion of the longitudinal direction (in FIG. 6, downward from the top in a tilted position in order to avoid the folded portion 26), and abuts against the downside projection 27. Accordingly, both sides of the guard portion 35a are retained by the claw portions 28 which face each other as in the case in FIG. 3(a), and by retaining the upper side by the folded portion 26 and retaining the lower side by the holding piece portion 29, the nut 35 is placed on the coaxial line with the through-bore 11a. As mentioned above, the structure supporting the nut 35 can be changed accordingly.

### Modified Example 2

FIGS. 7, 8 are modified examples of the glass holder 1. FIG. 7 is illustrated by corresponding to FIG. 1, and FIG. 8 is illustrated by corresponding to FIG. 5. Incidentally, in FIGS. 7, 8, the same symbols are assigned to the functionally same parts with the embodiments in FIGS. 1-5, and their duplicated explanations are omitted as much as possible.

In a glass holder 1A of the modified example, the first supporting plate portion 10 arranged in one face of the window glass 2 and the second supporting plate portion 20 arranged in the other face of the window glass 2 are connected through the hinge portion 30. The glass holder 1A can switch conditions of both supporting plate portions 10, 20 between, as shown in FIG. 7, the non-clamped condition wherein both supporting plate portions 10, 20 are opened through the hinge portion 30 and as shown in FIG. 8, the clamped condition wherein both supporting plate portions 10, 20 face each other through the hinge portion 30 and clamp the peripheral border portion of the window glass 2. The glass holder 1A includes the locking claws 6 as the temporary locking means which project from the first supporting plate portion 10 and lock in the window glass 2 in a retaining state by inserting the window glass 2 into the mounting bore 2a in the non-clamped condition; and an engaging piece 7A and a locking bore 23a as the holding means which are provided in both supporting plate portions 10, 20, engage each other in the clamped condition, and maintain the clamped condition, as in the case of the above-mentioned embodiment. However, in the glass holder 1A, an insertion portion 13A corresponding to the insertion portion 13 of the above-mentioned embodiment is simplified by omitting the bulging portions 8 or the retaining portions 9. Also, a portion 36b forming a female screw portion of a nut 36 is arranged inside the insertion portion 13A of the first supporting plate portion 10.

More specifically, the insertion portion 13A has a roughly tube shape forming a through-bore, and by using a part of the tube shape, two locking claws 6 are formed. The respective locking claws 6 are located to face each other in the tube shape, divided through a longitudinal slit on both sides, and include outward-looking claws at the ends of the pieces. When the locking claws 6 are penetrated into the mounting bore 2a while reducing the diameters, the locking claws 6 are elastically restored to the original state and locked in the edge of the mounting bore 2a. By inserting the portion 36b into the internal hole of the insertion portion 13A in the state wherein the nut 36 is held in the second supporting plate portion 20, the locking claws 6 expand the diameters and are pressed against the inner periphery of the mounting bore 2a of the window glass 2, and a temporary locking force of the locking claws 6 can be increased to a large extent. Consequently, in this modified example, the locking claws 6 (and a piece creating a space between the locking claws 6) can also serve a function for absorbing the wobble of the bulging portions of the above-mentioned embodiment. In this way, the glass holder of the invention is not limited to the above-mentioned basic embodiments and the details can be variously modified according to need. Also, the connection portion is not limited to the carrier plate as long as the connection portion is a place wherein the window glass is tightened.

The disclosure of Japanese Patent Application No. 2006-293586, filed on Oct. 30, 2006, is incorporated in the application.

While the invention has been explained with reference to the specific embodiments of the invention, the explanation is illustrative and the invention is limited only by the appended claims.

What is claimed is:

1. A glass holder for attaching a window glass with a mounting bore to a connection portion, comprising:
a first supporting plate portion;
a second supporting plate portion;
a hinge portion disposed between the first and second supporting plate portions so that the first and second supporting plate portions can face each other;
through-bores formed in the first and second supporting plate portions; and
a temporary locking device projecting from one of the two supporting plate portions to be able to lock the window glass by being inserted into the mounting bore in a non-clamped condition where said supporting plate portions open through the hinge portion.

2. A glass holder according to claim 1, further comprising a bolt inserted into the through-bores and the mounting bore in a condition that the window glass is clamped between the first and second supporting plate portions, and a nut engaging the bolt.

3. A glass holder according to claim 1, further comprising first and second holding devices provided at the first and second supporting plate portions near the hinge portion, the first and second holding devices engaging each other so that the window glass is clamped between the first and second supporting plate portions.

4. A glass holder according to claim 1, wherein said temporary locking device includes a plurality of locking craws arranged circularly to be able to engage the mounting bore of the window glass.

5. A glass holder according to claim 1, further comprising:
a cylindrical insertion portion provided in one of the first and second supporting plate portions for inserting into the mounting bore of the window glass;
temporary locking claws as said temporary locking device, said temporary locking claws forming a part of the cylindrical insertion portion and locking the window glass when inserted into the mounting bore in the non-clamped condition of the first and second supporting plate portion; and
a wobble-absorbing bulging portion forming a part of the cylindrical insertion portion, the wobble-absorbing bulging portion expanding outwardly to contact the mounting bore when a bolt is inserted into a hole of the cylindrical insertion portion.

6. A glass holder according to claim 5, wherein the locking claws and wobble-absorbing bulging portions are arranged alternately.

7. A glass holder for attaching a window glass with a mounting bore to a connection portion, comprising:
a first supporting plate portion;
a second supporting plate portion;
a hinge portion disposed between the first and second supporting plate portions so that the first and second supporting plate portions can face each other;
through-bores formed in the first and second supporting plate portions; and
first and second holding devices provided at the first and second supporting plate portions near the hinge portion, the first and second holding devices engaging each other so that the window glass is clamped between the first and second supporting plate portions.

8. A glass holder according to claim 7, further comprising:
a cylindrical insertion portion provided in one of the first and second supporting plate portions for inserting into the mounting bore of the window glass; and
temporary locking claws provided in a part of the insertion portion and locking in the window glass by inserting the insertion portion into the mounting bore in a non-clamped condition of the first and second supporting plate portions.

9. A glass holder according to claim 1, further comprising a bolt retaining portion for retaining the bolt.
